(19) United States
(12) Patent Application Publication
(10) Pub. No.: US 2026/0187657 A1
(43) Pub. Date: Jul. 2, 2026

(54) DETECTION OF PRICE FIXING OR TACIT COLLUSION BETWEEN AUTOMATED COMPUTING SYSTEMS

(71) Applicant: International Business Machines Corporation, Armonk, NY (US)

(72) Inventor: Ryan Anderson, Kensington, CA (US)

(21) Appl. No.: 19/003,065

(22) Filed: Dec. 27, 2024

(51) Int. Cl. G06Q 30/018; G06F 40/20

(52) U.S. Cl. CPC G06Q 30/0185; G06F 40/20

(57) ABSTRACT

Mechanisms are provided for detecting and alerting personnel to potential collusion between two or more artificial intelligence (AI) computer systems. An electronic document describing a regulation for participants in a marketplace is received that specifies requirements for avoiding collusion. Computer natural language processing, specifically configured for identifying significant features specific to regulating anti-collusion, is executed on the electronic document to thereby extract significant features. Rules for detecting behavior patterns indicative of collusion between AI computing systems are generated based on the extracted significant features and behavior monitoring agent(s) are deployed to monitor AI computing system operation in accordance with the rules. An operation of the AI computing system is classified as to exhibiting colluding behavior or not, based on the monitoring data and event information and application of the rules to the monitoring data and event information.

### BACKGROUND

The present application relates generally to a data processing apparatus and method and more specifically to a computing tool and computing tool operations/functionality for detecting price fixing or tacit collusion between automated computing systems.

The use of automated computing systems to set pricing of goods and services is ubiquitous in electronic commerce. For example, travel booking services, equity/stock exchanges and marketplaces, live performance ticket sales services, and the like, all use algorithms to determine the pricing of the products and services that they provide or for which they are a third party vendor. In many cases, these automated computing systems may include the use of artificial intelligence and advanced algorithms in computing systems to evaluate a large number of different factors to determine what the appropriate pricing for goods/services should be. Companies use these computing systems to attempt to obtain a competitive advantage over their competitors, maximizing profitability as a function of capacity utilization and price, while still ensuring compliance with regulations in regulated markets.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises receiving an electronic document describing a regulation for participants in a marketplace. The regulation specifies requirements for avoiding collusion between the participants. The method further comprises executing computer natural language processing, specifically configured for identifying significant features specific to regulating anti-collusion of participants, on the electronic document to thereby extract significant features. The method also comprises generating one or more rules for detecting behavior patterns indicative of collusion between artificial intelligence (AI) computing systems based on the extracted significant features. Moreover, the method comprises deploying a behavior monitoring agent to monitor an AI computing system operation, wherein the behavior monitoring agent is configured to monitor data and events corresponding to the one or more rules. In addition, the method comprises classifying an operation of the AI computing system based on monitoring data and event information reported by the behavior monitoring agent, by applying the one or more rules to the monitoring data and event information. The classification indicates whether the operation of the AI computing system is indicative of a collusion between the AI computing system and another AI computing system or not.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of an artificial intelligence (AI) compliance verification system in accordance with one illustrative embodiment;

FIG. 3 is a flowchart outlining an example operation for monitoring an AI computing system in response to a new or updated law, regulation, or policy in accordance with one illustrative embodiment; and

FIG. 4 is a flowchart outlining an example operation for performing an AI compliance verification in response to a new or updated law, regulation, or policy in accordance with one illustrative embodiment.

### DETAILED DESCRIPTION

The illustrative embodiments provide a computing tool and computing tool operations/functionality for detecting price fixing or tacit collusion between independent and competitive automated artificial intelligence (AI) computing systems, seeking to maximize each organization's profitability in a competitive marketplace. In the past, some organizations have been involved in human-to-human collusion, illegally coordinating behaviors to maximize profits by getting into explicit or tacit agreements to set pricing of products/services. In such situations, the organizations no longer act as competitors, but instead operate in concert to increase or artificially maintain price levels for their mutual benefit at the expense of customers. Such collusion required human efforts to enter into such arrangements. Recognizing such arrangements do not benefit the public, regulations have been passed for various marketplaces and industries to promote fair dealings and penalize any such collusion. However, while such collusion is still unlawful due to these regulations and laws promulgated by various oversight organizations and governments, the ability to detect such collusion and ensure compliance with these regulations is increasingly more difficult.

This is especially the case when one recognizes that commerce continues to migrate more to computing system-based marketplaces and exchanges, with increasingly complex and opaque computing systems and algorithms. Increasingly organizations are utilizing AI computing systems, e.g., neural networks, deep learning computer models, generative AI computer models, and the like, and advanced algorithms to determine pricing of goods/services in a competitive marketplace to try and obtain a competitive advantage while complying with applicable regulations. These AI computing systems and advanced algorithms are often so complex that, to the outside observer, and in many cases the technical architects, they operate as a type of “black box”. Once trained through machine learning processes, the AI computing system makes determinations and predictions given inputs based on the patterns of inputs seen through the machine learning training and the ground truth labels for these patterns indicating correct outputs that should be generated by the AI computing system.

Furthermore, the AI computing system may continue to learn through the user of a reward system that provides numerical feedback to the AI computing system based on its actions and performance in a given environment. This feedback guides learning of optimal behaviors over time. The rewards are represented by positive numerical values for desirable actions an negative values for undesirable actions. These rewards may include extrinsic rewards (provided by the environment), intrinsic rewards (generated by the AI computing system itself), and shaped rewards (combinations designed to encourage certain behaviors). The rewards are designed to align with the specific objectives of the task or problem that the AI computing system is trying to perform or solve. Some rewards are given immediate after an action, while others may be delayed until a specific goal is achieved. The AI computing system aims to maximize the total reward received over time; not just immediate rewards. The reward functions are carefully crafted to effectively guide the AI computing system's learning process and avoid unintended behaviors. By repeatedly interacting with the environment and receiving rewards, the AI computing system learns to make decisions that maximize the cumulative reward and ultimately improving the performance of the AI computing system for a given task.

For the most part, when an AI computing system is operating after training, i.e., during runtime operation, only the inputs and outputs are observable to the outside party who will not have any insight into the internal workings of the AI computing system. What is going on “under the hood” of the AI computing system is not readily perceivable and thus, it is difficult to determine the reasoning as to why an AI computing system generates a particular output given the inputs. This leads to difficulties in determining whether such AI computing systems are in violation of regulations or laws. The appearance of a violation is all that can be determined from the outputs. Moreover, violations may exist in the operation of the AI computing system, but due to the veil of the machine learning training and complexity of the AI computing system, such violations may not be able to be easily detected.

It has been found that, based on the way that AI computing systems and advanced algorithms operate, i.e., evaluating large number of factors including what the other AI computing systems and algorithms are determining for competitors, these systems and algorithms may in fact collude with one another to fix pricing. This collusion may not be intentional, but is a by-product of the training and logic of the AI computing system and algorithms attempting to “maximize reward”, and achieve a competitive advantage for their organization (market participant) over other organizations (other market participants) by analyzing patterns of data and determining pricing. This may occur without any knowledge on the part of the AI computing system and/or AI computing system provider that such pricing determinations result in an unintentional and tacit collusion or fixing of prices.

For example, with each market participant's AI computing system attempting to maximize profits by maximizing price and numbers of sales, each AI computing system will try to avoid overly reducing price of their product/services but do so enough to obtain more sales than their competitor(s). This will eventually lead, through various price adjustments, to competitor AI computing systems independently settling on a similar price for similar products/services as they evaluate various factors including what the competitor is doing, or other behavior that works in concert with the competitor to maximize profits for both competitors at the expense of consumers.

Moreover, while an organization (market participant) can assert that they are in compliance with regulations and laws, it is difficult to provide evidence of such compliance when the outputs provide an appearance of collusion and/or price fixing. Thus, there is a need for an improved computing tool and improved computing tool operations/functionality to monitor AI computing systems to detect possible collusion and present notifications of such possible collusion for evaluation with regard to laws, regulations, and policies that regulate the corresponding market or industry. Moreover, it is desirable to perform such detection while taking into account explain-ability of AI computing systems with regard to internal states of the AI computing system relative to the outputs generated by the AI computing systems. These new laws, regulations, or policies may be due to an oversight organization decision making, court ruling, establishment of international standards, or the like. Organization policies may be the result of an organization attempting to “get ahead” of laws, regulations, or the like, that the organization sees will be applicable in the future, or to implement best practices to avoid potential legal issues that may arise.

With the mechanisms of the illustrative embodiments, when a new law or regulation, change to a law or regulation, an internal change in an organization's compliance policy, or the like, is implemented, this may act as a triggering event for operations of the illustrative embodiments to check for compliance of AI computing systems and provide notifications of any violations of such laws, regulations, or compliance policies. Alternatively, a periodic compliance check may be performed to ensure that systems of an organization are still operating in compliance with existing laws, regulations, or policies.

The details of the new or modified laws, regulations, or policies are documented in unstructured natural language content and/or structured content of electronic documents. These electronic documents may be processed by natural language processing and machine learning computer models of the present invention to extract the salient features of the new or modified laws, regulations, or policies. These electronic documents may be distributed by the oversight organizations, government agencies, or the like, to participants in regulated marketplaces as notifications regarding monitoring and compliance requirements that these participants must adhere to. These electronic documents may be distributed in many different known ways, may be posted at a known location on one or more data networks for access by participants, or the like. The electronic documents are input to the AI compliance verification system of the illustrative embodiments for implementation in monitoring AI computing systems for compliance, and specifically for compliance with laws, regulations, and policies directed to avoiding collusion, price fixing, or other practices that reduce marketplace competition.

An AI compliance verification system of the illustrative embodiments comprises natural language processing (NLP) mechanisms to parse and analyze the electronic documentation of these laws, regulations, and policies to extract the salient or significant features. These significant features may be extracted using any number of different NLP techniques including the use of dictionaries, synonym lists, named entity recognition, knowledge bases, ontologies, and the like, to identify the significant features from the natural language content of the electronic documentation. In some cases, structured data formats may be used such that the extraction may extract specific fields of the known structured data formats. The extracted features identify the elements of a computing system that need to be monitored and the criteria by which to determine whether a computing system is or is not in compliance with the laws, regulations, or policies.

The AI compliance verification system may also implement a language model, or fine-tuned large language model (LLM), which operates on the extracted features and can provide information for explain-ability regarding compliance or non-compliance of participant systems (computing systems of a participant organization in an electronic marketplace). The concept of explain-ability refers to the ability to explain an AI computer model's output and the operation of the AI computer model in a way that a human being can accept as making sense. In general, there are two main approaches to explain-ability, global explain-ability and local explain-ability. Global explain-ability focuses on understanding the overall behavior of the AI computer model and how features in the data collective affect the results. Local explain-ability examines individual instances and features and explains how specific inputs lead to particular outputs.

Explain-ability information is information that can be used to evaluate and understand the reasons for AI computer model decision making and output generation. For example, some explain-ability algorithms determine levels of importance of internal states and nodes of an AI computer model with regard to particular outputs, to thereby identify which states/nodes contributed most to the final output of the AI computer model. In this way, a type of explanation as to what drives the output of the AI computer model may be obtained. Other types of explain-ability information may be obtained from using rules-based explanations which capture the logic behind an AI computer model's output. An example of one type of rule-based model is a decision tree which provides insights into how the AI computer model arrives at its decisions.

Moreover, in other cases, explain-ability information may be obtained by using the local explanation methods which operate to explain individual outputs rather than the entire AI computer model. For example, Local Interpretable Model-Agnostic Explanations (LIME) is one mechanism that approximates a decision boundary of the AI computer model locally around a specific instance by perturbing the instance's features and observing the resulting changes in the AI computer model's output. Based on the perturbations and observations, LIME approximates the AI computer model's behavior near the instance using a local surrogate model, such as a linear regression model.

Various types of explain-ability algorithms and models have been developed, which may be adapted to the particular monitoring of systems in the illustrative embodiments using the extracted features of laws, regulations, and policies generated by the mechanisms of the illustrative embodiments. In short, any currently known or later developed explain-ability algorithms that correlate outputs of AI computer models with inner states of the AI computer model for explaining the basis and reasoning of the AI computer model in generating the output, may be used without departing from the spirit and scope of the present invention.

For purposes of the following description, it will be assumed that a rules-based explain-ability mechanism is utilized in which the rules are generated from the extracted features using a language model (LM) or fine-tuned LLM to generate the actual rules from these extracted features. The rules may be generated using distribution-based explain-ability methods, feature attribution methods, model reporting methods, and/or methods that evaluate published results. With distribution-based explain-ability methods, experiments are performed on input variations to observe effects on outputs and generate corresponding rules representing the correlations. With feature attribution methods, the contribution of internal parts of the AI computer model on outputs is identified and corresponding rules representing these correlations may be generated. With model reporting methods, detailed document about a model's architecture, training data, and its known limitations may be obtained and analyzed by natural language processing mechanisms of the LM/LLM and other analysis to extract correlations for representation as rules. For methods that evaluate published results, a similar processing of documentation detailing performance metrics of a model across various tasks may be used to identify correlations and formulate rules.

The rules generated by the LM/LLM are rules for monitoring and ensuring compliance with the laws, regulations, and policies and which may be implemented in compliance checking logic of the illustrative embodiments to actually monitor an organization's computing systems and detect compliance violations and flag atypical behavior which indicates elevated risk of non-compliant behavior. It should be appreciated that while a rules-based explain-ability implementation is used herein, this is not intended to be limiting on the possible embodiments and any explain-ability mechanisms or logic may be used to correlate AI computer model decision making and behavior with AI computer model outputs may be used without departing from the spirit and scope of the present invention.

The rules generated by the LM/LLM inform the AI compliance verification system as to what the AI compliance verification system should be monitoring and the criteria for evaluating the operation of computing systems. These rules may be applied to the outputs and explain-ability information generated by the explain-ability tools, that correlate internal states and operations of the AI computing system to the outputs, to determine whether the AI computing system is operating in compliance with these rules, and thus the laws, regulations, and policies, or is not in compliance, i.e., there is a violation due to a possible collusion of the AI computing system with another AI computing system. That is, the rules may specify the collusive patterns that should be detected. These collusive patterns may be correlated with behavior statistics, metrics, explain-ability information, and the like, that are indicative of these collusive patterns.

For example, in a marketplace where participant organizations bid for projects or sales, a collusive pattern may be of the type where a same participant organization wins the bids most of the time, where the metrics for detecting such may be the number and fractions of wins, by region, by sector, etc. Another collusive pattern may be bid rotation where the indicative metrics may be time series descriptors of winners. Yet another collusive pattern may be that few or no new participants are present (a histogram of participation distribution may be the indicative metric, bidding that does not erode the target price (bid to reserve price statics is an indicative metric), and participant withdrawal (withdraw counted by bid and participant may be the indicative metric). Various types of collusion patterns may be defined along with corresponding metrics, data, and events for detecting such collusion patterns being correlated with these collusion patterns (behavior patterns).

As another example, consider an example airline use case in which fares and pricing are obtained from the Airline Tariff Publishing Company (ATPCO). The ATPCO collects and distributes fare data from hundreds of airlines, with systems processing millions of fare changes each day. The users of ATPCO's data are global distribution systems (GDSs) and their associated travel agent, central reservation systems (CRS) of airlines, online travel agencies (OTAs), and other service providers in the travel industry. While the following example will focus on ATPCO and GDSs, it should also be appreciated that the travel industry is gradually transitioning from ATPCO to a New Distribution Capability (NDC) and NDC data aggregators, which may also be monitored for collusion in accordance with one or more of the illustrative embodiments.

Currently, the GDSs play a crucial role in the airline ticket marketplace by acting as a centralized platform that connects airlines, travel agencies, and consumers. The following is a summary of how a GDS operates for airplane ticket marketplaces. Initially, the GDS collects and consolidates real-time flight information from multiple airlines, including: schedules and routes from sources such as the Official Aviation Guide (OAG), Fares and pricing from the ATPCO, and seat availability from individual airline reservation systems. This aggregated data is then integrated into a unified database accessible to travel agents and online booking platforms.

When a travel agent or consumer searches for flights, the GDS processes the search criteria (e.g., dates, destinations, etc.), queries its database for matching flights, compiles and presents available options, including prices and seat availability, and provides mechanism to enable comparison of different airlines and itineraries. Once a flight is selected, the GDS facilitates the booking process by communicating with the airline reservation system to confirm availability, reserving the selected seats, generating the issuing electronic tickets, and updating inventor across all connected systems to prevent overbooking.

The GDS continuously receives and processes updates from airlines regarding changes in pricing, seat availability, schedule modifications, and special promotions or offers. This ensures that travel agents and consumers have access to the most current information. Some GDS also offer integrated payment solutions allowing for seamless transaction processing. Moreover, some GDS may provide additional functionalities, such as ancillary service bookings (e.g., seat selection, baggage fees, etc.), travel policy compliance checks for corporate bookings, reporting and analytics tools for travel agencies, and the like. By centralizing these operations, GDS platforms streamline the process of searching, comparing, and booking flights, making it easier for travel agencies to serve their clients and for airlines to distribute their inventor efficiently.

In this example use case, the compliance rule generation may utilize the GDS as both a source of data for generation of compliance rules by analyzing the data collected by and reported to the GDS from the various airlines, as well as a platform for which the AI compliance verification system may operate to ensure that airline systems are not in collusion with one another. That is, initially the data obtained by the GDS may be the subject of rule generation by identifying system interactions that are not in violation or are in violation of the laws/rules, and identifying those that are not. Thereafter, the rules may be applied to the GDS to monitor and verify compliance of airline systems with anti-collusion laws/regulations through this centralized platform.

Having generated the rules, the AI compliance verification system determines if the AI compliance verification system already performs the requisite monitoring or if modifications to one or more components of the AI compliance verification system needs to be made to implement the requisite monitoring. For example, there may be a monitoring mechanism in place that needs a small adjustment to monitor for new things or be made more sensitive to certain types of operations or data. This is a type of gap analysis that identifies the gaps between what is already monitored by the AI compliance verification system and what is not already monitored but needs to be monitored, i.e., the gaps. In some illustrative embodiments, it may be assumed that there are no in-place mechanisms for performing the requisite monitoring and new mechanisms may be configured and deployed, e.g., new monitoring agents may be deployed onto computing systems to monitor for specific performance metrics specified in the generated rules.

In a gap analysis in accordance with the illustrative embodiments, assume that it is determined that there is a new monitoring that needs to be implemented, e.g., some new gathering of data and computations are needed to determine whether particular behaviors of the monitored computing systems are typical (not indicative of collusion) or atypical (potentially indicative of collusion). This new monitoring looks for particular patterns of behavior on the part of the AI computing systems utilized by various organizations of a particular marketplace or industry, where this pattern of behavior may be indicative of collusion, such as tacit price fixing or the like. Also assume, for purposes of illustration, that there is no current monitoring mechanism in place to monitor the required behavior but that the new laws, rules, or policies require such monitoring to demonstrate compliance or detect atypical patterns that are indicative of collusion. For example, a regulatory agency or oversight organization may become aware of a type of behavior pattern representative of collusion and may promulgate laws, rules, or policies to detect and disincentivize such patterns of behavior.

As an example, assume that the AI compliance verification system is configured to detect possible price fixing of airline tickets between airlines or travel companies. In such an example, an atypical pattern may be one in which, on a first set of days of the week an airline's (or travel company's) pricing of flights on a flight leg from a first city to a second city may be relatively higher than a second airline's pricing, but relatively lower on a second set of days of the week, while the second airline's pricing of flights for the same flight leg may be relatively lower than the first airline's pricing on the first set of days, but relatively higher on the second set of days of the week. This is indicative of a possible situation in which the AI computing systems of the first and second airlines (or travel companies), in attempting to maximize profits for their respective companies, have settled into a situation where the first airline or travel company has determined to not be competitive with the second airline (travel company) during the second set of days of the week because during the first set of days of the week the first airline can maximize profits that outweighs the possible losses on the second set of days. The second airline reaches an opposite decision making and determines to not be competitive on the first set of days of the week so that it can maximize profits during the second set of days of the week. These decisions may have been reached independently of each other by the AI computing systems, yet are dependent upon what the other AI computing system is deciding. Hence, a type of tacit price fixing and colluding is reached by the AI computing systems without this being intentional on the part of the airlines or travel companies. This results in higher prices for the consumer and extra profits for the colluding companies. If regulators observed this pattern between human beings who were responsible for these decisions, they would likely determine that a law, rule, or policy was being violated and that there was collusion or anti-competitive behavior involved. However, detecting such behavior in automated AI computing systems cannot be as clearly performed.

An AI compliance verification system may not be already monitoring for such patterns in pricing of these airlines or travel companies. Using the gap analysis, it may be determined that the AI compliance verification system does not monitor for such behavior patterns or some of the underlying data that may be used to detect such behavior patterns. For these gaps in monitoring, the AI compliance verification system configures and deploys appropriate behavior monitoring agents to the monitored computing systems to gather the required data and perform analysis of behavior patterns. For example, this analysis may include determining a frequency of updates of the pricing of tickets for particular flight legs serviced by the airline (or travel company), determining an amplitude of the cut in pricing being made on certain days of the week, an inactivity of price changes on certain days of the week, etc. Various other analysis may be performed in addition to or replacement of one or more of these analyses, including counting a number of bids, determining how unusual the prices and the pricing activity is compared to other days of the week for other airline routes or flight legs, or the like. For example, various statistical analysis methodologies, clustering methodologies for detecting outliers, and the like, can be used to determine how usual or unusual certain patterns in the data are.

The AI compliance verification system may process the monitoring data and information obtained from the behavior monitoring agents and perform analysis of this monitoring data and information to determine if the behavior represented by this data and information is typical or atypical (i.e., potentially indicative of collusion). Such analysis may invoke one or more analytics, one or more trained machine learning computer models that look at patterns of input data and make a classifications as to whether these patterns are indicative of a particular classification of typical or atypical, and/or the like. This analysis and classification may involve a risk scoring analysis which evaluates the risk that the observed behavior by the behavior monitoring agents is indicative of collusion or not. The actual scoring may operate on various different factors in the data returned by the behavior monitoring agents.

In some illustrative embodiments, the scoring may be based on a statistical outlier detection methodology that identifies data points in a dataset that significantly deviate from the expected patterns. Examples of such statistical outlier detection mechanisms include a Z-score method that measures how many standard deviations a data point is from a mean of the dataset, an interquartile range (IQR) method that uses quartiles to identify outliers (e.g., data points falling below Q1−1.5*IQR or above Q3+1.5*IQR are potential outliers), and the like. Numerical values may be assigned to each data point indicating a degree of how much of an outlier the data point is, with higher scores indicating a higher likelihood of being an outlier, which allows for ranking and prioritizing potential outliers for further investigation. Moreover, in some illustrative embodiments, a distance-based scoring may be utilized in which a distance of a point from a center of the data is measured, a density-based scoring may be utilized that evaluates how isolated a point is compared to its neighbors, or a model based scoring may be utilized that compares observed values to those predicted by a statistical model and the differences are quantified. Thus, statistical outlier detection combined with scoring mechanisms may be used to determine if behaviors represented by the data and information are representative of typical or atypical behaviors.

Based on the scoring and subsequent classification, it can be identified whether the particular monitored computing system is in compliance or is in violation of the particular laws, rules, or policies. For example, when monitoring a competitive marketplace for potential tacit collusion, the AI compliance verification system may look for several key signals in the data, such as instances where competitor prices move in lockstep, especially if price changes occur simultaneously or in quick succession without apparent market justification, and unusually stable prices across competitors, particularly in markets where prices typically fluctuate. In some illustrative embodiments, the AI compliance verification system may operate to flag rapid, automated price adjustments that seem to respond directly to competitor actions, potentially indicating algorithmic tacit collusion. In some illustrative embodiments, the AI compliance verification system may operate to flag sudden alignment of previously diverse strategies among competitors, such as similar promotional activities or product offerings. In some illustrative embodiments, the AI compliance verification system may flag unusually stable market shares over time, especially in dynamic markets, which may indicate collusion directed to maintaining the status quo. In some illustrative embodiments, the AI compliance verification system may flag synchronized capacity expansions or reductions across competitors without clear market drivers, and increased public statements or announcements that could be interpreted as signals to competitors about future pricing or strategy intentions.

Various data analytics techniques using the identification of patterns by the application of the rules, statistical analysis, and scoring mechanisms, etc. of the illustrative embodiments may be used to identify these various patterns. For example, the data analytics techniques of the AI compliance verification system can measure the mutual information between competitor actions to quantify the degree of potential coordination, can perform outlier detection using statistical methods to identify behaviors that deviate from expected norms, perform temporal analysis of temporal patterns in pricing, production, or other key variables to detect unusual synchronization, monitor for coordinate actions that may raise barriers to new market entrants, identify atypical responses to demand changes that seem coordinated across competitors, and the like. By employing these monitoring and data analytics techniques, the AI compliance verification system can help detect potential tacit collusion. However, it is important to note that under current laws, such as that of the United States of America, tacit collusion alone may not constitute an antitrust violation without additional evidence of an agreement between competitors. The AI compliance verification system may thus, provide a tool for assisting with the identification of antitrust violations but may require further investigation and analysis by human experts to determine if any antitrust concerns are indeed present.

It should be appreciated that each of the various market participant organizations may implement their own version of the AI compliance verification system for monitoring and evaluating the behaviors of their corresponding computing systems. In so doing, the AI compliance verification systems are performing their own self-policing by implementing the laws, rules, and regulations issued by the regulatory and oversight organizations on their own monitored computing systems, i.e., their own AI computing systems. These participant organizations are providing their own attestations which may be provided to the regulatory or oversight organization for verification and compliance with reporting requirements. These attestations or reports may present the explain-ability information for the AI computing systems and/or other information required to demonstrate proper monitoring and compliance verification performed by the AI compliance verification system.

In some illustrative embodiments, the self-policing reporting may be further augmented with a third party AI compliance verification system, possibly implemented by the regulatory or oversight organization. This third party AI compliance verification system may operate on the attestations of the various market participant organizations to evaluate cross-organization patterns of behavior which may be indicative of potential collusion. That is, each individual participant may attest that, from their viewpoint, that they are in compliance with the applicable laws, rules, or policies. However, when one looks at the patterns of behavior across multiple organizations, it may be determined that while each individual one believes they are in compliance, the cross organization patterns indicate a possible unintentional collusion on the part of the AI computing systems of the various market participants. The third party AI compliance verification system may operate on the attestations from a plurality of the market participants to score patterns of behavior across these market participants with regard to whether or not these patterns of behavior are indicative of collusion or not. Based on the scoring across the participants, particular participants that may be purposefully, or inadvertently, colluding may be identified and a corresponding notification of such provided to human regulators.

It should be appreciated that, in scenarios, where there is nothing amiss, i.e., where the AI compliance verification system at the participant, or the third part AI compliance verification system, determines that it is monitoring the data and operations that need to be monitored to demonstrate compliance with the laws, rules, and policies currently applicable, and the data being monitored is indicative of a normal and typical operation with no signs of collusion or other outlier behavior, the AI compliance verification system can make a publication of its findings. That is, the AI compliance verification system can publish, for example, an electronic document (e.g., PDF) that provides a report or otherwise provide an output visualization, message, graphical user interface element, or the like, to memorialize the determination of no violations for human usage. This may be a report or output that is then confirmed, acknowledge, or otherwise certified by a human being that is ultimately responsible for the attestation of proper operation to the regulatory agency, oversight organization, or the like.

In scenarios where something amiss is detected, i.e., a behavior that is potentially indicative of collusion, a log may be generated and an internal human review process may be initiated, thereby creating an audit trail. Again, this potential collusion may be unintentional on the part of the market participant, but is achieved through automated “black box” operations of the AI computing systems employed by the market participant. For example, using the airline ticket sales example again, the AI computing systems are seeking to maximize profitability and competitiveness, but in doing so are unintentionally signaling to each other, and the result is tacit collusion which runs afoul of existing laws, rules, and policies. That is, assume that trading is happening in the airline market and prices are set in the marketplace with customers buying the tickets at various prices and airlines periodically cutting prices on certain days for certain flights or flight legs. Because the automated AI computing systems are seeking to maximize their rewards by looking at all signals that may influence these rewards, these automated AI computing systems will examine the data from the trades performed by other AI computing systems of competing participants, to determine its own recommended pricing. The other participant's AI computing systems will do likewise, and this may result in a pattern of behavior where each participant cuts prices on days that benefit them and increases prices on days where competition is not necessary to maximize rewards. Such behavior is indicative of collusion and will be flagged by the AI compliance verification system using outliner detection mechanisms, such as clustering and the like noted above. That is, if the AI computing system is determined to be having a consistent pattern of cutting prices at a specified frequency over a period of time, the cuts being equal to or more than a predetermined threshold, and the prices being increased in a similar pattern during other time periods in a consistent manner, this may be indicative of a pattern of behavior determined from potential collusion with other AI computing systems.

Detected instances of such behavior patterns on the part of AI computing systems may be flagged for further investigation. Moreover, the flagged instances may be provided to one or more LMs/LLMs to generate explanations for the detected behavior patterns. That is, through natural language processing and LM/LLM logic, the evidence associated with the detected behavior patterns may be analyzed to identify reasons for the detected behavior patterns and formulate natural language explanations of the flagged behavior. This natural language explanation may be provided to authorized users via an alert message presented in one or more different ways, such as Short Message Service (SMS) alert notification, a graphical user interface (GUI) output in a dialog or the like, an email notification, or any other means by which to present a notification to authorized personnel of the potential atypical behavior patterns. The authorized personnel may be a compliance officer and may receive the alert notification on their corresponding portable or non-portable data communication device. In some illustrative embodiments, the alert notifications may include adding notations to logs in natural language outlining the date and time of the detected behavior pattern, the scope and the methods used for the analysis that detected the behavior pattern, the amplitude of any deviations from a given norm, e.g., a difference is score, and the like.

In some cases, visual mechanisms may be used to convey alert notification information to humans. In some illustrative embodiments, these visual mechanisms may include graphical representations, such as a large circle with zones (like a clock) in which activities that are within the safe center zone are not of interest as outliers, but as activity is clustered towards the perimeter, this represents greater risk of the AI computing system being in violation of laws, rules, or policies against collusion. The visual mechanisms take high dimensional and complex data and make it more consumable by human beings by overlaying this information into a visual framework. For example, assuming the circular representation is mapped to the face of an analog clock, then zones edging towards “3 o'clock” may signify a zone of risk of collision around certain airline routes, for example the San Francisco to Calgary route, whereas other zones, e.g., near the “6 o'clock” position, may indicate a temporary or all day of the week anomaly. In another manifestation of visual output the system can create a three dimensional representation where the X axis may represent a risk of non-compliance, the Y axis may represent the number of transactions in a period of time, and the Z axis may represent the magnitude of the funds being transacted, where the latter may map to penalty/fine size, for example.

The visualization mechanisms of the illustrative embodiments will allow different types of users to gain information regarding regulatory compliance who may otherwise not be familiar with such. For example, users whose training may be in statistics or computer programming may not have the necessary understanding for regulatory constructs or how to demonstrate compliance with such regulations and the visualizations of the illustrative embodiments will allow more understandability on the part of such users.

Thus, the illustrative embodiments provide mechanisms for taking laws, regulations, or policies expressed in unstructured natural language content and/or in structured data structures, and extract the relevant features for detecting compliance or non-compliance with such laws, regulations, or policies. The illustrative embodiments provide mechanisms for converting these extracted features into rules for detecting compliance or non-compliance and providing explain-ability of such detections in the operation of AI computing models. The rules may be used to determine whether existing AI compliance verification systems already monitor for the necessary behavior patterns to evaluate these rules and/or are sufficiently sensitive to the criteria set forth in the rules. Based on this determination, the mechanisms of the illustrative embodiments deploy new behavior monitoring agents or reconfigure existing behavior monitoring agents to perform the necessary behavior pattern detection, i.e., monitoring for the specific data and events that indicate the particular behavior patterns that are to be detected. The behavior monitoring agents operate on their respective AI computing systems and return information corresponding to these monitored data and/or behavior pattern detections to their corresponding AI compliance verification systems. The AI compliance verification systems score and classify the information received from the behavior monitoring agents to determine whether the monitored AI computing system is in compliance with the laws, rules, or policies, or is in non-compliance and performs an appropriate action in response, e.g., sending a notification of non-compliance, logging a result, presenting a visualization, or the like.

It should be appreciated that while the description of the illustrative embodiments herein will focus on anti-trust laws, regulations, and policies directed to policing collusion and tacit price fixing, the illustrative embodiments are not limited to such and may be applied to any desirable laws, regulations, policies and/or regulatory guidance for which AI computing systems are to be monitored to detect potential violations. Such monitoring of compliance with other laws, regulations, policies and/or regulatory guidance may be performed in addition to, or in replacement of, the monitoring for collusion behaviors. That is, in some illustrative embodiments, even though the AI compliance verification system may be primarily concerned with patterns of behaviors indicative of potential collusion, if other activities happen that are indicative of potential violations of laws, regulations, policies, or guidance, these situations may be flag and appropriate notifications and outputs generated to inform authorized personnel. For example, if an AI computing system exhibits behaviors of indicative of issuing attacks on another AI computing system, in violation of laws, regulations, policies, and guidance, then this behavior may be identified as well and flagged. The AI compliance verification system may operate to detect atypical behaviors with regard to any established laws, regulations, policies, or guidance and provide appropriate flagging and notifications for further investigation.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides computer functionality for detecting tacit collusion, e.g., price fixing, between automated AI computing systems and providing alert notifications when such tacit collusion is detected. The improved computing tool implements mechanism and functionality, such as an AI compliance verification system, which cannot be practically performed by human beings either outside of, or with the assistance of, a technical environment, such as a mental process or the like. The improved computing tool provides a practical application of the methodology at least in that the improved computing tool is able to detect potential collusion between automated AI computing systems based on laws, regulations, and policies directed to preventing such collusion.

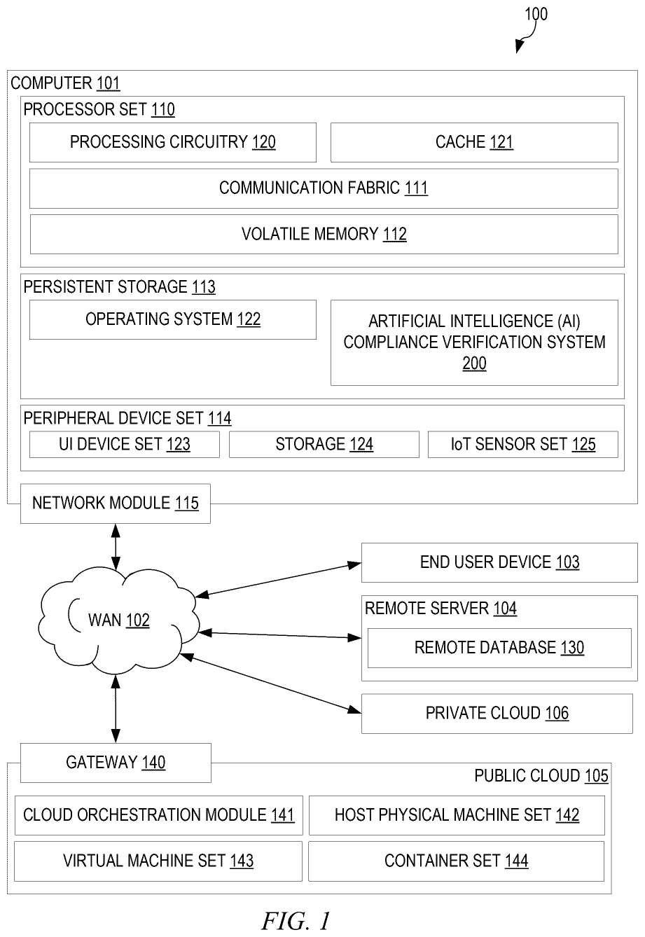

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as AI compliance verification system 200. In addition to AI compliance verification system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and AI compliance verification system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in AI compliance verification system 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in AI compliance verification system 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement an AI compliance verification system 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described herein, the implementation of the mechanisms of the illustrative embodiments improves the functionality of the computing device and provides a useful and concrete result that facilitates detection of tacit collusion between automated AI computing systems which may violate established laws, regulations, or policies and provides alert notifications as to such. In so doing, the mechanisms of the illustrative embodiments leverage explain-ability techniques and tools for AI computer systems as a basis for scoring the operation of the AI computing system and classifying the operation as to whether it is in compliance or not in compliance.

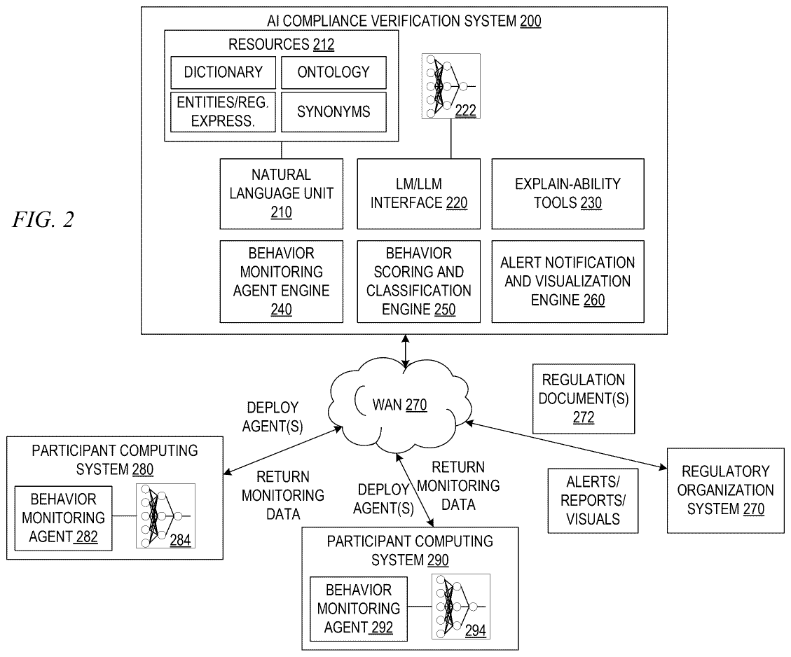

FIG. 2 is an example block diagram illustrating the primary operational components of an AI compliance verification system in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to detecting potential collusion, either intentional or unintentional, between automated AI computing systems in violation of established laws, regulations, or policies and notifying appropriate authorized personnel, regulators, and the like, of the possibility of such collusion.

Again, as noted above, since the AI computing systems 284, 294 of market participant organizations 280, 290 are essentially “black boxes” from the outside observer, such as a regulator or other oversight organization, it is not practically possible for a human being to manually or mentally determine the internal operation of such AI computing systems. The illustrative embodiments provide a specific computer technology solution that implements natural language processing and Language Models (LMs) to understand the laws, regulations, or policies that are applicable to verify compliance of AI computing systems, especially with regard to anti-collusion laws, regulations, and policies. The illustrative embodiments provide a specific computer technology solution that implements explain-ability techniques and mechanisms for AI computing systems, mechanisms for determining how to monitor for the underlying data and events that may be used to determine compliance/non-compliance in view of applicable laws, regulations, or policies, and computer mechanisms for scoring and classifying such data and events representing behaviors of AI computing systems as to whether they are in compliance are out of compliance with established laws, regulations, or policies. Moreover, the illustrative embodiments further provide alert notification and visualization mechanisms to make it easier for human beings to be notified of, verify, and respond to such possibilities of collusion between automated AI computing systems. These mechanisms cannot practically be performed by human beings and are not any method of organizing human activity, but instead are specifically directed to an automated computing technology specifically directed to addressing the problems of compliance of AI computing systems with anti-collusion laws, regulations, and policies with the understanding that the AI computing systems operate as “black boxes” whose internal operations are, in general, not observable externally.

As shown in FIG. 2, the AI compliance verification system 200 comprises a natural language unit (NLU) 210, a LM/LLM interface 220, one or more explain-ability tools 230, behavior monitoring agent engine 240, behavior scoring and classification engine 250, and alert notification and visualization engine 260. While the AI compliance verification system 200 is shown as a separate entity from the participant systems 280, 290, in FIG. 2 for ease of illustration, it should be appreciated that each of the participant systems 280, 290 may implement their own instances of the AI compliance verification system 200 to perform a self-policing of their AI computing systems 284, 294. That is, rather than having a centralized AI compliance verification system 200, individual instances may be associated with each separate participant computing system 280, 290 and each separate participant computing system may report to the regulatory or oversight computing system 270 their reports and alerts indicating compliance/non-compliance with anti-collusion laws, regulations, and policies for AI computing systems. In some illustrative embodiments, a centralized AI compliance verification system 200 may be utilized to operate on data reported by behavior monitoring agents 282, 292 of the participant computing systems 280, 290 and/or the individual instances of AI compliance verification systems 200 that may be implemented in each participant computing system 280, 290.

The AI compliance verification system 200, as well as the regulatory organization computing system 270 and participant computing systems 280, 290 may comprise one or more computing devices, such as servers, client computers, and the like. These systems 200 and 270-290 further comprise necessary infrastructure, software, storage devices, and the like, to facilitate computer based data communication both internally within each system 200 and 270-290, as well as between such systems 200 and 270-290 via one or more data networks 202. In general, the regulatory organization system 270 distributes or otherwise makes available to the other systems 200 and 270-290, electronic documents and structured data specifying the laws, regulations, or policies that are to be enforced by the market participants with regard to the operation of the AI computing systems, and specifically with regard to protecting against collusion and tacit price fixing of products/services. These electronic documents, referred to herein as regulation documents 272, may be consumed by the AI compliance verification system 200 as described herein to determine how to automate compliance evaluations to ensure that the AI computing systems 284, 294 of the market participant computing systems 280, 290 are in compliance or report non-compliance.

The NLU 210 of the AI compliance verification system 200 performs natural language processing (NLP) operations on the regulation documents 272 distributed or otherwise made available by the regulatory organization computing system 270 to determine how to implement monitoring and verification of AI computing system operations in accordance with these laws, regulations, and policies specified in the regulation documents 272. The NLU 210 and its NLP algorithms are specifically configured for the particular market of the market participants being regulated so as to identify the key features of natural language content and/or structured content of the regulation documents 272 that are relevant to the monitoring and verification of AI computing system operations in the particular marketplace. This specific configuration may involve configuring the NLU 210 to utilize market specific resources 212 that are a basis for the NLP operations performed, such as entity extraction, regular expression detection, analyzing content according to market specific ontologies, analyzing content according to market specific dictionaries, synonyms, and the like. Existing computer NLP techniques may be used, but which are specifically configured for the particular marketplace and specifically for extracting features from the regulation documents 272 that may be used to generate rules for monitoring and verifying operations of AI computing systems. LMs/LLMs may utilize ontologies, such as in ontology-guided retrieval augmented generation (ORAG), named entity recognition and fine-grained entity typing, dynamic retrieval augmented generation of ontologies using AI to generate ontological components from existing knowledge and unstructured text, text-to-knowledge graph conversion, and the like, which may be leveraged by the NLU 210 as resources 212 for performing its operations.

Based on this specific configuration of the NLU 210, the NLU 210 parses and analyzes the regulation documents 272 to extract significant or key features. In some cases, structured data formats may be used such that the extraction may extract specific fields of the known structured data formats. The extracted features identify the elements of an AI computing system, e.g., AI computing systems 284, 294, that need to be monitored and the criteria by which to determine whether an AI computing system is or is not in compliance with the laws, regulations, or policies described in the regulation documents 272.

The significant features extracted from the regulation documents 272 may be provided to a language model (LM), or fine-tuned large language model (LLM), which operates on the extracted significant features to generate one or more rules for determining compliance/non-compliance of the operation of an AI computing system with laws, regulations, or policies, and specifically anti-collusion/anti-trust laws, regulations, or policies. The LM/LLM 222 may be implemented in the AI compliance verification system 200 itself, or may be accessed from another computing system (not shown) via the LM/LLM 222 interface 220. For example, the LM/LLM 222 may be a third party LM/LLM 222 provided by a service provider, and which may be fine-tuned through machine learning processes, for the specific purpose of generating rules from features extracted from regulation documents.

In some illustrative embodiments, a LM/LLM 222 prompt based invoking of the LM/LLM 222 may be utilized by the LM/LLM interface 220, in which the prompt comprises a static portion that specifies the task the LM/LLM 222 is to perform (e.g., generate a rule to verify compliance of an AI computing system), the tools available to the LM/LLM 222 in performing the task, the type and format of the response that the LM/LLM 222 is to generate, and a dynamic portion, also referred to as a context, upon which the LM/LLM 222 may operate to perform the task. In some illustrative embodiments, the context may include the extracted features that are extracted from the regulation document 272 by the NLU 210. The LM/LLM 222 generates a rule specifying the data and events to be monitored and the criteria by which to evaluate whether this data or events indicates compliance or non-compliance with the laws, regulations, or policies specified in the regulation document 272. The data and events represent the behavior patterns of AI computing systems that are to be checked. This may be data and events in the outputs of AI computing systems, for example, and/or data and events corresponding to the internal state and operations of an AI computing system. These data and events may be the basis for outlier detection, scoring, and classification relative to the criteria in the applicable rules so as to identify typical/atypical behaviors of AI computing systems, both individually and in combination with one another.

The rules generated by the LM/LLM may be provided to the other elements 230-260 for performing their various operations. The rules generated by the LM/LLM 222 are rules for monitoring and ensuring compliance with the laws, regulations, and policies documented in the regulations document 272 taking into account explain-ability information generated by one or more explain-ability tools 230 that operate to provide insights into the reasoning why an AI computing system generates a particular output. The rules generated by the LM/LLM 222 inform the AI compliance verification system 200 as to what the AI compliance verification system 200 should be monitoring with behavior monitoring agents 282, 292, and the criteria for evaluating the operation of the AI computing systems 284, 294. That is, the rules may specify the collusive behavior patterns that should be detected. These collusive behavior patterns may be correlated with behavior statistics, metrics, and the like, that are indicative of these collusive behavior patterns, and which may be monitored and gathered by the behavior monitoring agents 282, 292.

Moreover, the rules may evaluate explain-ability information, in that if the collusive behavior patterns are detected, explain-ability information may further be evaluated to determine if these collusive behavior patterns are indeed due to collusion or are otherwise explainable. For example, if the internal state and operations of the AI computing system 284 indicates that the AI computing system 284 makes determinations of pricing based primarily on a historical pattern of activity of the other AI computing system 294, then this may be indicative of a potential collusion. However, if the decision is equally based on other factors that are not indicative of collusion, e.g., seasonal changes, weather effects, unexpected increased demand, or other factors that are not specific to the behavior of a competitor AI computing system or which are not determined to reduce competition, then the explain-ability information may indicate a lower likelihood that the output, while appearing to be collusion, is in fact not due to collusion.

As noted above, the explain-ability information is information that can be used to evaluate and understand the reasons for AI computer model decision making and output generation. The explain-ability tools 230 may implement one or more explain-ability algorithms, such as those that determine levels of importance of internal states and nodes of an AI computer system 284, 294 with regard to particular outputs, to thereby identify which states/nodes contributed most to the final output of the AI computer system 284, 294. In this way, a type of explanation as to what drives the output of the AI computer system 284, 294 may be obtained. Alternatively, or in addition, the explain-ability tools 230 may implement other explain-ability algorithms such as rules-based explanations which capture the logic behind an AI computer system's output, local explanation algorithms which operate to explain individual outputs rather than the entire AI computer system (e.g., LIME), or the like.

The explain-ability tools 230 automate metadata capture and document key facts about the AI computer system. The explain-ability tools 230 drive transparency on lifecycle stages for different AI computer systems and versions for use cases in a single view. The explain-ability tools 230 provide point-in-time audit capabilities by being able to export AI factsheets as reports, across the AI computer system lifecycle. These AI factsheets contain information about the AI computer system's development, capabilities, benchmark performance, and the like.

Once an AI computer system 284, 294 is targeted by the explain-ability tools 230, such as by loading the AI computer model for the AI computer system 284, 294 into the explain-ability tools 230, the explain-ability tools 230 access the AI computer model's inventor to view all registered assets, and starts tracking the AI computer model's operations in the AI factsheet. The AI factsheet may be regularly or continuously monitored for AI model performance and pattern evaluations and provide explain-ability for any such performance changes and/or the occurrence of patterns matching those looked for by the generated rules. The explain-ability tools 230 may utilize a datamart to store all AI computer model inputs and outputs, which it uses to calculate the AI computer model metrics, with these metrics being able to be configured as needed for the particular implementation, and being integrated with the AI factsheet data.

The rules generated by the LM/LLM 222 and accessible via the LM/LLM interface 220, may further be utilized by the behavior monitoring agent engine 240 to determine if the AI compliance verification system 200 already has behavior monitoring agents deployed to the participant computing systems 280, 290 to monitor and gather the necessary data and event information to evaluate the criteria specified in the rules. To create points of integration for LM/LLMs 222 hosted in the same environment as well as those external to the AI compliance verification system 200, API access and credentials are established and flows are created to interact with the LM/LLM 222, where the flows are designed to accept input, process it through the LM/LLM 222, and return the result. Error handling and fallback logic are further implemented for API failures or rate limiting issues, and policies for fallback from external LM/LLM to an internal LM/LLM may be implemented.

The analysis by the behavior monitoring agent engine 240 may be a type of gap analysis that identifies the gaps between what is already monitored by the behavior monitoring agents 282, 292 of the AI compliance verification system 200, and what is not already monitored but needs to be monitored, i.e., the gaps. Agent orchestrator logic of the behavior monitoring agent engine 240 may provide a list of the agents 282, 292, their objective, date of operation, and other attributes and may compare this listing to a “need to monitor listing” generated by analysis of the rules, and then summarize any monitoring items that are missing or areas that are not clear. In some illustrative embodiments, it may be assumed that there are no in-place mechanisms for performing the requisite monitoring and new behavior monitoring agents 282, 292 may be configured and deployed to the participant computing systems 280, 290, which may supersede any existing behavior monitoring agents.

Assuming that the gap analysis performed by the behavior monitoring agent engine 240 determines that there is a new monitoring, or modified monitoring, that needs to be implemented, e.g., some new gathering of data and/or computations are needed to determine whether particular behaviors of the monitored AI computing systems 284, 294 are typical or atypical (potentially collusive activity), existing agents 282, 292 may be reconfigured or new agents 282, 292 may be generated and deployed with configurations to specifically monitor for and gather and report the necessary data and event information to allow for evaluation of the rules generated by the LM/LLM 222 based on the significant features extracted by the NLU 210 from the regulation documents 272. This new monitoring by the new or reconfigured agents 282, 292 looks for particular patterns of behavior on the part of the AI computing systems 284, 294 utilized by various participant computing systems 280, 290.

The behavior monitoring agents 282, 292 deployed to the participant computing systems 280, 290 monitor the corresponding AI computing systems 284, 294 by gathering the requisite data regarding the operation of the AI computing systems 284, 294 and/or events occurring in the AI computing systems 284, 294. This may include invoking explain-ability tools 230 to correlate the outputs generated by the AI computing systems 284, 294 with the internal states and operations of the AI computing systems 284, 294. The behavior monitoring agents 282, 292 may perform some analytics and processing of the collected data and event information to generate metrics of interest for evaluating the performance of the AI computing systems 284, 294 with regard to the rules generated by the LM/LLM 222. The agents 282, 292 may collect data and event information corresponding to behaviors that are of interest, e.g., groups with high cohesion and exclusivity in their bidding patterns, artificially inflated pricing, outliers indicative of a number of price changes that is out of the ordinary, or other significant changes in pricing, etc. which may be indicative of collusion. The configuring, deployment, and interactions and communication with the behavior monitoring agents 282, 292 may be orchestrated by the behavior monitoring agent engine 240.

The AI compliance verification system 200 may receive and process the monitoring data and event information obtained from the behavior monitoring agents 282, 292 and perform further analysis of this monitoring data and event information to determine if the behavior represented by this data and information is typical or atypical (i.e., potentially indicative of collusion). That is, the behavior scoring and classification engine 250 may execute logic to implement the rules generated by the LM/LLM 222 on the monitoring data and event information to determine whether the monitoring data and event information meets the criteria of behavior patterns specified in one or more of the rules. Such analysis may invoke one or more analytics, one or more trained machine learning computer models that look at patterns of input data and make a classifications as to whether these patterns are indicative of a particular classification of typical or atypical operations, and/or the like. This analysis and classification may involve a risk scoring analysis which evaluates the risk that the observed behavior by the behavior monitoring agents is indicative of collusion or not.

The actual scoring may operate on various different factors in the data returned by the behavior monitoring agents. The scoring may be used as a basis for determining how “typical” the corresponding pattern of factors, which together represent a behavior, is relative to a baseline, which may be a predetermined pattern, other data in the dataset, or the like. For example, the scoring may look to see whether a pricing is within a +/−30% window of a baseline price, or instead represents a premium or “low compete” pricing. Such scoring may be used for outlier detection using any of the previously mentioned outlier detection algorithms above.

The scoring generates a numerical value which may then be used to classify the behavior into one of a plurality of possible classifications, e.g., normal, possibly atypical, definitely atypical, or the like. These classifications may be used to trigger corresponding alerts and visualizations via the alert and visualization engine 260. As on example, the scoring may be used to determine statistical outliers on a normal curve using a scale of 1 to 10. In such a case, a Z-score methodology may be adapted for determining outliers indicative of collusion, e.g., 1-3: typical non-collusion behavior (not outliers), 4-6: unusual values that are potentially indicative of collusion, and 7-10: extreme outliers that are highly indicative of collusion.

In more detail, scores 1-3 may be a Z-score between −2 and 2 indicating that these values fall within two standard deviations of the mean and are considered representative of typical or normal behaviors. Score 4 may correspond to a Z-score in the range of −2.5 and −2, or 2 and 2.5. These values are starting to become unusual but are not yet clear outliers. Score 5 may correspond to a Z-score in the range of −3 and −2.5, or 2.5 and 3. These values are more unusual and might be considered mild outliers. Score 6 may correspond to a Z-score between −3.5 and −3, or 3 and 3.5. These values are quite unusual and are generally considered outliers. Score 7 may correspond to a Z-score between −4 and −3.5, or 3.5 and 4 These are clear outliers, well beyond the typical range and thus, may be flagged as representative of collusive behavior. Score 8 may correspond to a Z-score between −4.5 and −4, or 4 and 4.5, and is indicative of very extreme outliers and highly collusive behaviors. Score 9 may correspond to a Z-score between −5 and −4.5, or 4.5 and 5 and are almost certainly indicative of collusive behavior. These are highly unusual values, rarely seen in most datasets. Score 10 may correspond to a Z-score below-5 or above 5. These are the most extreme outliers, exceptionally rare in normal distributions. In this example, score values with Z-scores beyond ±3 are considered outliers and indicative of collusive behaviors. The scale becomes more granular for extreme values, allowing for differentiation between moderate and severe outliers.

Based on the scoring and subsequent classification, it can be identified whether the particular monitored computing system is in compliance, is likely in violation, or is in violation of the particular laws, rules, or policies. In particular, the scoring and classification as to the “typical” or “atypical” nature of behaviors may be used to detect compliance, which is assumed to be the “typical” behavior, or non-compliance, which is assumed to be an “atypical” behavior. The classification, as well as the underlying data and metrics, explain-ability information, and the like, may be provided to the alert and visualization engine 260 to thereby generate alert notifications and visualizations for informing authorized users of the compliant or non-compliant operation of the AI computing systems 284, 294. These alert notifications and visualizations may take many different forms depending on the desired implementation. The alert notification and visualization engine 260 of the AI compliance verification system 200 can publish, for example, an electronic document (e.g., PDF) that provides a report or otherwise provides an output visualization, message, graphical user interface element, or the like, to memorialize the determination of no violations, possible violations, or actual violations for human usage. This may be a report or output that is then confirmed, acknowledge, or otherwise certified by a human being that is ultimately responsible for the attestation of proper operation to the regulatory organization system 270. Moreover, the alert notification and visualization engine 260 may generate logs for internal review processes and auditing. Thus, the alert notifications and visualizations may be presented to participant organization personnel and/or to the regulatory organization system 270 for reporting of compliance to the regulatory or oversight organization.

The alert notifications, visualizations, and/or logs may correlate possible violations and/or violations to specific rules generated by the LM/LLM 222 and the corresponding laws, regulations, or policies of the regulation document 272. In addition, any explain-ability information that may be indicative of the reasoning for the outputs from the AI computing systems 284, 294 may be presented as well. In some cases, the alert notifications and visualizations may be generated by one or more LMs or LLMs that operate on the scores, classifications, explain-ability information, and the like, to generate a natural language explanation of the outputs of the AI computing system 284, 294. This explanation presents the reasoning of the decisions made by the AI computing system 284, 294, which may be a way of justifying the decision made or may be an indictment of the decision by showing that an unintentional collusion between AI computing systems 284, 294 occurred.

This natural language explanation may be provided in the alert notifications and/or visualizations to authorized users, such as via an alert message presented in one or more different ways, e.g., Short Message Service (SMS) alert notification, a graphical user interface (GUI) output in a dialog or the like, an email notification, or any other means by which to present a notification to authorized personnel of the potential atypical behavior patterns. The authorized personnel may be a compliance officer of the participant organization, a regulator of the regulatory organization, or the like, and may receive the alert notification on their corresponding portable or non-portable data communication device. In some illustrative embodiments, the alert notifications may include adding notations to logs in natural language outlining the date and time of the detected behavior pattern, the scope and the methods used for the analysis that detected the behavior pattern, the amplitude of any deviations from a given norm, e.g., a difference is score, and the like.

In some cases, visual mechanisms may be used to convey alert notification information to humans. In some illustrative embodiments, these visual mechanisms may include graphical representations, such as a large circle with zones (like a clock) in which activities that are within the safe center zone are not of interest as outliers, but as activity is clustered towards the perimeter, this represents greater risk of the AI computing system being in violation of laws, rules, or policies against collusion. The visual mechanisms take high dimensional and complex data and make it more consumable by human beings by overlaying this information into a visual framework. The visualization mechanisms of the illustrative embodiments will allow different types of users to gain information regarding regulatory compliance who may otherwise not be familiar with such.

As noted previously, it should be appreciated that each of the various market participant organizations operating systems 280, 290 may implement their own version of the AI compliance verification system 200 for monitoring and evaluating the behaviors of their corresponding AI computing systems 284, 294. In this way, the individual instances will operate based on the monitoring data and event information presented by the behavior monitoring agents 282, 292. In such embodiments, the AI compliance verification systems of each of the systems 280, 290 are performing their own self-policing by implementing the laws, rules, and regulations issued by the regulatory and oversight organizations on their own monitored computing systems, i.e., their own AI computing systems. These participant organizations are providing their own attestations which may be provided to the regulatory or oversight organization for verification and compliance with reporting requirements. These attestations or reports may present the explain-ability information for the AI computing systems and/or other information required to demonstrate proper monitoring and compliance verification performed by the AI compliance verification system.

In some illustrative embodiments, the self-policing reporting may be further augmented with a centralized AI compliance verification system 200, possibly implemented by the regulatory or oversight organization. This centralized AI compliance verification system 200 may operate on the attestations of the various market participant organizations, i.e., the outputs generated by the individual instances of the AI compliance verification system in each of the participant computing systems 280, 290, to thereby evaluate cross-organization patterns of behavior which may be indicative of potential collusion. That is, each individual participant computing system, via their instances of system 200, may attest that, from their viewpoint, that they are in compliance with the applicable laws, rules, or policies. The individual instances of the system 200 operate based on the monitoring data, event information, explain-ability information, and the like, specific to that participant computing system 280, 290 and its AI computing system 284, 294, as obtained from the behavior monitoring agent 282, 292. However, the centralized AI compliance verification system operates based on the attestations from the individual instances of system 200.

In this way, while each individual instance of system 200 may attest that their AI computing systems 284, 294 are in compliance, when the centralized AI compliance verification system 200 looks at the patterns of behavior across multiple organizations, it may be determined that while each individual one believes they are in compliance, the cross organization patterns indicate a possible unintentional collusion on the part of the AI computing systems of the various market participants. The centralized AI compliance verification system 200 may operate on the attestations from a plurality of the market participants to score patterns of behavior across these market participants with regard to whether or not these patterns of behavior are indicative of collusion or not. Based on the scoring across the participants, particular participants that may be purposefully, or inadvertently, colluding may be identified and a corresponding notification of such provided to human regulators.

Thus, the illustrative embodiments provide mechanisms for taking laws, regulations, or policies expressed in unstructured natural language content and/or in structured data structures, and automatically translate such laws, regulations, or policies into logic for monitoring, scoring, and classifying the operations of AI computing systems with regard to compliance with the laws, regulations or policies. The illustrative embodiments use explain-ability information for AI computing systems to determine whether the internal operations of the AI computing systems indicate that the outputs generated are based on collusion between AI computing systems or not. This information may be used to generate appropriate alert notifications, visualizations, and reports for attesting to the proper operation of the AI computing systems in compliance with applicable laws, regulations, and policies, or to report possible/actual violations so that they may be proper addressed.

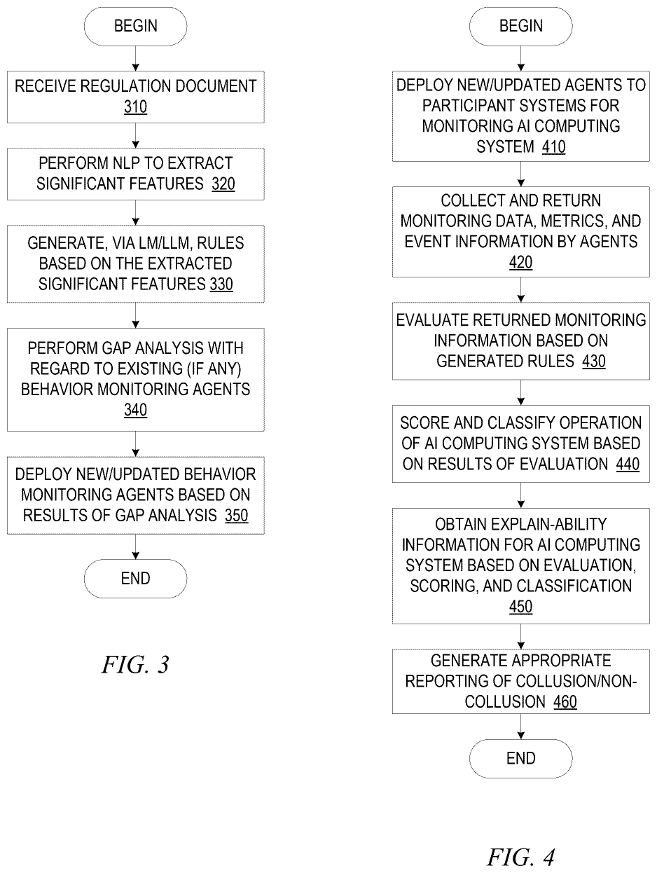

FIG. 3 is a flowchart outlining an example operation for monitoring an AI computing system in response to a new or updated law, regulation, or policy in accordance with one illustrative embodiment. FIG. 4 is a flowchart outlining an example operation for performing an AI compliance verification in response to a new or updated law, regulation, or policy in accordance with one illustrative embodiment. It should be appreciated that the operations outlined in FIGS. 3-4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 3-4, and may, in some cases, make use of the results generated as a consequence of the operations set forth in FIGS. 3-4, the operations in FIGS. 3-4 themselves are specifically performed by the improved computing tool in an automated manner.

With reference to FIG. 3, the operation starts with the distribution or otherwise making available of an electronic document specifying, in natural language content and/or structured content, the requirements for a new or updated law, regulation, or policy for protecting against AI computing system collusion (step 310). The electronic document is processed by specifically configured natural language processing for the particular marketplace to extract significant features from the electronic document (step 320). The extracted significant features are then used as a basis for formulating, via a LM/LLM, rules for implementing the requirements of the law, regulation, or policy (step 330). The rules may then be used to perform a gap analysis to determine whether behavior monitoring agents already monitor the required data and event information for evaluating the rule or if new behavior monitoring agents or updates to monitoring agents is needed (step 340). If new or updated monitoring agents are needed, these behavior monitoring agents are configured and deployed to the participant systems implementing the AI computing system that is to be monitored (step 350). The operation then terminates.

With reference now to FIG. 4, the operation starts with the deployment of the new or updated behavior monitoring agent(s) to the participant systems which implement the AI computing systems to be monitored (step 410). The behavior monitoring agents return data indicating the metrics and event information for evaluation of rules corresponding to the laws, regulations, and policies governing the marketplace (step 420). The monitoring data, metrics, and event information may be evaluated by behavior scoring and classification logic that implements the rules generated by the LM/LLM for identifying behavior patterns indicative of potential collusion between AI computing systems (step 430). The monitoring data, metrics, and event information are scored and classified as to whether they indicate normal operation, possible collusion, or actual collusion of the AI computing system with other AI computing systems (step 440). Explain-ability information is obtained from explain-ability tools associated with the AI computing system as well, and evaluated to adjust scoring and classification (step 450). Appropriate reporting is then generated to indicate normal, possible collusion, or actual collusion and violation of the laws, regulations, and policies, which may include LM/LLM generation of natural language content to explain the results, visualizations, or the like (step 460). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method comprising:
receiving an electronic document describing a regulation for participants in a marketplace, wherein the regulation specifies requirements for avoiding collusion between the participants;
executing computer natural language processing, specifically configured for identifying significant features specific to regulating anti-collusion of participants, on the electronic document to thereby extract significant features;
generating one or more rules for detecting behavior patterns indicative of collusion between artificial intelligence (AI) computing systems based on the extracted significant features;
deploying a behavior monitoring agent to monitor an AI computing system operation, wherein the behavior monitoring agent is configured to monitor data and events corresponding to the one or more rules, wherein deploying the behavior monitoring agent further comprises performing a gap analysis between the one or more rules and current deployment of monitoring agents to the AI computing system to determine data and events not currently being monitored and for which one or more monitoring agents are to be deployed; and
classifying an operation of the AI computing system based on monitoring data and event information reported by the behavior monitoring agent, by applying the one or more rules to the monitoring data and event information, wherein the classification indicates whether the operation of the AI computing system is indicative of a collusion between the AI computing system and another AI computing system or not.

2. The method of claim 1, further comprising, in response to the classification of the operation of the AI computing system being indicative of the collusion between the AI computing system and the another AI computing system, generating explain-ability information for the AI computing system by processing, by a fine-tuned language model that is fine-tuned for explaining an AI computing system operation, features extracted from the monitoring data and event information.

3. The method of claim 1, wherein classifying the operation of the AI computing system comprises performing an outlier analysis on the monitoring data and event information to determine whether the monitoring data and event information indicate a typical or atypical behavior pattern.

4. (canceled)

5. The method of claim 1, wherein classifying the operation of the AI computing system comprises generating a numerical score quantifying a risk that the operation of the AI computing system corresponds to a collusive behavior pattern, wherein the numerical score is computed by one of a Z-score method, an outlier quantification method, or a distance calculation method.

6. The method of claim 1, further comprising generating an output specifying the classification of the operation of the AI computing system and explain-ability information specifying factors leading to the operation of the AI computing system determined to be indicative of collusion or determined to be not indicative of collusion.

7. The method of claim 6, wherein the output is one of a log of the operation of the AI computing system for subsequent review, a posting of an electronic document detailing the classification of the operation of the AI computing system, or an alert message transmitted to one or more authorized user computing devices.

8. The method of claim 1, further comprising outputting an alert to one or more authorized user computing devices in response to the classification of the operation of the AI computing system indicating possible collusion with the another AI computing system, wherein the alert comprises a visualization representing the operation of the AI computing system.

9. The method of claim 1, wherein the one or more rules are for detecting at least one of a first behavior pattern that identifies a group of AI computing systems with high cohesion and exclusivity in bidding patterns for the group of AI computing systems, a second behavior pattern that identifies artificially inflated pricing, or a third behavior pattern that identifies outliers indicative of an atypical number of price changes.

10. The method of claim 1, wherein the electronic document is received in response to one of; the regulation being distributed as a newly created regulation; the regulation being distributed as a modified regulation based on a previous regulation; a new internal policy of an organization being distributed; or a modified policy of the organization being distributed based on a previous policy of the organization.

11. A computer program product comprising:
one or more computer-readable storage media; and
program instructions stored on the one or more computer-readable storage media to perform operations comprising:
receiving an electronic document describing a regulation for participants in a marketplace, wherein the regulation specifies requirements for avoiding collusion between the participants;
executing computer natural language processing, specifically configured for identifying significant features specific to regulating anti-collusion of participants, on the electronic document to thereby extract significant features;
generating one or more rules for detecting behavior patterns indicative of collusion between artificial intelligence (AI) computing systems based on the extracted significant features;
deploying a behavior monitoring agent to monitor an AI computing system operation, wherein the behavior monitoring agent is configured to monitor data and events corresponding to the one or more rules, wherein deploying the behavior monitoring agent further comprises performing a gap analysis between the one or more rules and current deployment of monitoring agents to the AI computing system to determine data and events not currently being monitored and for which one or more monitoring agents are to be deployed; and
classifying an operation of the AI computing system based on monitoring data and event information reported by the behavior monitoring agent, by applying the one or more rules to the monitoring data and event information, wherein the classification indicates whether the operation of the AI computing system is indicative of a collusion between the AI computing system and another AI computing system or not.

12. The computer program product of claim 11, wherein the operations further comprise, in response to the classification of the operation of the AI computing system being indicative of the collusion between the AI computing system and the another AI computing system, generating explain-ability information for the AI computing system by processing, by a fine-tuned language model that is fine-tuned for explaining an AI computing system operation, features extracted from the monitoring data and event information.

13. The computer program product of claim 11, wherein classifying the operation of the AI computing system comprises performing an outlier analysis on the monitoring data and event information to determine whether the monitoring data and event information indicate a typical or atypical behavior pattern.

14. (canceled)

15. The computer program product of claim 11, wherein classifying the operation of the AI computing system comprises generating a numerical score quantifying a risk that the operation of the AI computing system corresponds to collusive behavior pattern, wherein the numerical score is computed by one of a Z-score method, an outlier quantification method, or a distance calculation method.

16. The computer program product of claim 11, wherein the operations further comprise generating an output specifying the classification of the operation of the AI computing system and explain-ability information specifying factors leading to the operation of the AI computing system determined to be indicative of collusion or determined to be not indicative of collusion.

17. The computer program product of claim 16, wherein the output is one of a log of the operation of the AI computing system for subsequent review, a posting of an electronic document detailing the classification of the operation of the AI computing system, or an alert message transmitted to one or more authorized user computing devices.

18. The computer program product of claim 11, wherein the operations further comprise outputting an alert to one or more authorized user computing devices in response to the classification of the operation of the AI computing system indicating possible collusion with the another AI computing system, wherein the alert comprises a visualization representing the operation of the AI computing system.

19. The computer program product of claim 11, wherein the one or more rules are for detecting at least one of a first behavior pattern that identifies a group of AI computing systems with high cohesion and exclusivity in bidding patterns for the group of AI computing systems, a second behavior pattern that identifies artificially inflated pricing, or a third behavior pattern that identifies outliers indicative of an atypical number of price changes.

20. A computer system comprising:
a processor set;
one or more computer-readable storage media; and
program instructions stored on the one or more computer-readable storage media to cause the processor set to perform operations comprising:
receiving an electronic document describing a regulation for participants in a marketplace, wherein the regulation specifies requirements for avoiding collusion between the participants;
executing computer natural language processing, specifically configured for identifying significant features specific to regulating anti-collusion of participants, on the electronic document to thereby extract significant features;
generating one or more rules for detecting behavior patterns indicative of collusion between artificial intelligence (AI) computing systems based on the extracted significant features;
deploying a behavior monitoring agent to monitor an AI computing system operation, wherein the behavior monitoring agent is configured to monitor data and events corresponding to the one or more rules, wherein deploying the behavior monitoring agent further comprises performing a gap analysis between the one or more rules and current deployment of monitoring agents to the AI computing system to determine data and events not currently being monitored and for which one or more monitoring agents are to be deployed; and
classifying an operation of the AI computing system based on monitoring data and event information reported by the behavior monitoring agent, by applying the one or more rules to the monitoring data and event information, wherein the classification indicates whether the operation of the AI computing system is indicative of a collusion between the AI computing system and another AI computing system or not.

21. The method of claim 1, further comprising, in response to the classification indicating that the operation of the AI computing system is indicative of collusion with the another AI computing system, generating explain-ability information for the AI computing system by determining, for a particular output of the AI computing system, levels of importance of internal states and nodes of the AI computing system with respect to the particular output to identify which of the internal states and nodes contributed to the particular output, and outputting an alert to one or more authorized user computing devices, wherein the alert comprises a graphical user interface (GUI) output including a visualization representing the operation of the AI computing system and a natural language explanation based on the explain-ability information.

22. The computer program product of claim 11, wherein the operations further comprise, in response to the classification indicating that the operation of the AI computing system is indicative of collusion with the another AI computing system, generating explain-ability information for the AI computing system by determining, for a particular output of the AI computing system, levels of importance of internal states and nodes of the AI computing system with respect to the particular output to identify which of the internal states and nodes contributed to the particular output, and outputting an alert to one or more authorized user computing devices, wherein the alert comprises a graphical user interface (GUI) output including a visualization representing the operation of the AI computing system and a natural language explanation based on the explain-ability information.
